(19) United States
(12) Patent Application Publication
(10) Pub. No.: US 2011/0000062 A1
(43) Pub. Date: Jan. 6, 2011

(54) Christmas mini light bulb remover

(76) Inventor: Raymond Kolasa, Farmington Hills, MI (US)

Correspondence Address: Raymond Kolasa, 28937 Spyglass, Farmington Hills, MI, 48331, US

(21) Appl. No.: 11/789,450

(22) Filed: Jul. 2, 2009

(51) Int. Cl. B25B 9/02; H01K 3/32

(52) U.S. Cl. 29/278

(57) ABSTRACT

A light bulb remover tool has a slot at one end insertable into the space between a light bulb holder and a light bulb socket. Downward force exerted on the opposite end of the tool creates a leverage force to separate the light bulb holder from the socket. The tool is a one piece member having a U-shaped slot on one end.

### BACKGROUND OF THE INVENTION

The present invention relates to an improved Christmas mini light bulb removal tool.

### SUMMARY

A U-shape slot is formed in one end of thin rigid body and is insertable between a small opening between the light bulb holder and the upper edge of the bulb socket.

### BRIEF DESCRIPTION OF THE DRAWINGS

The description herein makes reference to the accompanying drawings:

FIG. 1 is a plan view of the present light bulb remover.

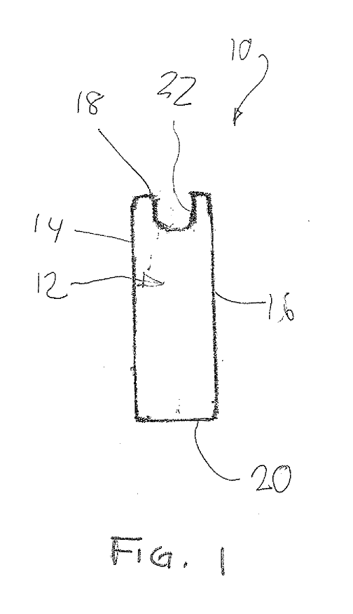

### DETAILED DESCRIPTION

The present invention is a Christmas mini light bulb remover or tool used to separate light bulbs or light bulb holders from the base or sockets in multiple mini light bulb strings.

The tool 10 is in the form of a generally flat, planar body 12 formed of a relatively rigid material. For example, the body 12 may have a thickness of about 0.020 to about 0.025 inches, a length of about 1.5 inches, and width of about 0.5 inches. The body 12, for example, has a rectangular shape formed of two opposed sides 14, 16 and two opposed ends 18, 20.

One of the ends 18 is formed with an inward extending, U-shaped slot 22. The slot 22, for example, can have a width of between 0.280 and 0.282 inches a length, of 0.25 inches and terminates in an inner 0.25 inch radius

The slot 22 can be inserted between the small opening between the base of a light bulb holder and the upper edge of the socket in which the light bulb is mounted. A downward force on the end 20 of the tool 10 directed toward the bottom of the light string socket exerts an oppositely directed counter force which unseats and separates the light bulb holder from the light string socket.

What is claimed is:

1. A light bulb removal tool comprising:
a one piece body having a periphery;
a slot extending inward from the periphery of the tool and adapted to be placed in a leveraging position between a light bulb holder and light bulb socket.

2. The tool of claim 1 wherein:
the slot is a U-shaped slot.
